(19) United States
(12) Patent Application Publication
(10) Pub. No.: US 2024/0310188 A1
(43) Pub. Date: Sep. 19, 2024

(54) Altitude Contextualization for Calibrating a Barometric Pressure Sensor of a Mobile Device

(71) Applicant: NextNav, LLC, Sunnyvale, CA (US)

(72) Inventors: Michael DORMODY, San Jose, CA (US); Wei LIU, Sunnyvale, CA (US)

(73) Assignee: NextNav, LLC, Sunnyvale, CA (US)

(21) Appl. No.: 18/599,901

(22) Filed: Mar. 8, 2024

Related U.S. Application Data
(60) Provisional application No. 63/489,957, filed on Mar. 13, 2023.

(51) Int. Cl. G01C 25/00; G01C 5/06

(52) U.S. Cl. CPC G01C 25/00; G01C 5/06

(57) ABSTRACT

Estimated positions of a computing device and whether the computing device is inside a building are determined. Atmospheric pressure measurements are collected when inside the buildings using a barometric pressure sensor of the computing device. Heights of the buildings are determined. Calibration values based on the heights of the buildings and the atmospheric pressure measurements are determined. A combined calibration value is determined based on the plurality of calibration values. The combined calibration value corresponds to a numerical overlap region of the plurality of calibration values.

### RELATED APPLICATIONS

This application claims priority to U.S. Provisional Patent Application No. 63/489,957, filed Mar. 13, 2023, all of which is incorporated herein by reference for all purposes.

### BACKGROUND

Determining the exact location of a mobile device (e.g., a smartphone operated by a user) in an environment can be quite challenging, especially when the mobile device is located in an urban environment or is located within a building. Imprecise estimates of the mobile device's altitude, for example, may have life-or-death consequences for the user of the mobile device since the imprecise altitude estimate can delay emergency personnel response times as they search for the user on multiple floors of a building. In less dire situations, imprecise altitude estimates can lead a user to the wrong area in an environment.

Different approaches exist for estimating an altitude of a mobile device. In a barometric-based positioning system, altitude can be computed using a measurement of atmospheric pressure from a calibrated barometric pressure sensor of a mobile device along with ambient pressure measurement(s) from a network of calibrated reference pressure sensors and a measurement of ambient temperature from the network or other source. The barometric pressure sensor of the mobile device is typically inexpensive and susceptible to drift over time. Consequently, the pressure sensor must be frequently calibrated. A typical approach for calibrating a barometric pressure sensor involves determining a calibration offset value that, when applied to a measurement of pressure by the pressure sensor, results in an estimated altitude that is within a tolerated amount of distance from the true altitude.

Unfortunately, the barometric pressure sensor of a mobile device cannot be calibrated at every location of the mobile device, especially when the mobile device is not at a known altitude (e.g., of a waypoint). Not knowing the true altitude of a location within a tolerated amount of error makes calibration impractical at such a location. However, calibration still must occur regularly despite the above issues.

### SUMMARY

In some aspects, the techniques described herein relate to a method including: determining a first estimated position of a computing device; determining, based on the first estimated position, that the computing device is inside a first building; collecting first atmospheric pressure measurements inside the first building using a barometric pressure sensor of the computing device; identifying a height of the first building; determining a first calibration value based on the height of the first building and the first atmospheric pressure measurements; determining a combined calibration value based on the first calibration value and a second calibration value that was determined for the first building or a second building, the combined calibration value corresponding to a numerical overlap region of the first calibration value and the second calibration value; and calibrating the barometric sensor using the combined calibration value.

In some aspects, the techniques described herein relate to a method including: determining a plurality of estimated positions of a computing device; determining, based the plurality of estimated positions, each time that the computing device is inside respective buildings of a plurality of buildings; collecting a plurality of atmospheric pressure measurements when inside the respective buildings of the plurality of buildings using a barometric pressure sensor of the computing device; identifying a respective plurality of heights of the plurality of buildings; determining a plurality of calibration values based on the heights of the buildings and the atmospheric pressure measurements; determining a combined calibration value based on the plurality of calibration values, the combined calibration value corresponding to a numerical overlap region of the plurality of calibration values; and calibrating the barometric sensor using the combined calibration value.

In some aspects, the techniques described herein relate to a method including: determining a plurality of estimated positions of a computing device; collecting a plurality of atmospheric pressure measurements at the plurality of estimated positions using a barometric pressure sensor of the computing device; determining a plurality of horizontal uncertainty regions corresponding to the plurality of estimated positions; determining a plurality of terrain distributions corresponding to the plurality of horizontal uncertainty regions; determining a plurality of calibration values based on the plurality of terrain distributions and the atmospheric pressure measurements; determining a combined calibration value based on the plurality of calibration values, the combined calibration value corresponding to a numerical overlap region of the plurality of calibration values; and calibrating the barometric sensor using the combined calibration value.

### BRIEF DESCRIPTION OF THE DRAWINGS

FIG. 1 is a simplified view of an operational environment for altitude contextualization for calibrating a barometric pressure sensor of a mobile device, in accordance with some embodiments.

FIG. 2 provides a simplified example of a portion of a process for altitude contextualization for calibrating a barometric pressure sensor of a mobile device, in accordance with some embodiments.

FIG. 3A shows a simplified side view of example buildings and select attributes, in accordance with some embodiments.

FIG. 3B shows a simplified side view of the example buildings of FIG. 3A with determined calibration values of a mobile device, in accordance with some embodiments.

FIG. 4 provides a simplified example graph illustrating how the individual calibration values introduced in FIG. 3B are used to generate a combined calibration value for a mobile device, in accordance with some embodiments.

FIG. 5 provides a graph of a distribution of example calibration confidence values determined using a barometric pressure sensor of a mobile device over time in a variety of locations within a region, in accordance with some embodiments.

FIG. 6 provides a graph of example results for determining a peak overlap of the calibration confidence values shown in FIG. 5, in accordance with some embodiments.

FIG. 7 provides a simplified topographic map of the bumpy or hilly terrain shown in FIG. 1, in accordance with some embodiments.

FIG. 8 illustrates the components of a transmitter, a mobile device, and a server of the operational environment shown in FIG. 1, in accordance with some embodiments.

### DETAILED DESCRIPTION

The barometric pressure sensor of a mobile device (i.e., a computing device) typically cannot be calibrated at every location of the mobile device-especially when the mobile device is not at a known altitude. One conventional approach is to limit calibration to opportunities when the mobile device is in a conducive environment for data collection, for example when the device is still, the device is outside and unaffected by building effects, and/or the device is located in a flat area. Examples of such methods are described in U.S. Pat. No. 11,073,441, which issued on Jul. 27, 2021, and is entitled “Systems and Methods for Determining When to Calibrate a Pressure Sensor of a Mobile Device”, all of which is incorporated herein in its entirety for all purposes.

However, such constraints limit calibration of the mobile device's barometric pressure sensor to occasions when the mobile device is in a very specific situation. This limitation coupled with potentially sparse data from a customer device and little to no control over when and how data can be collected may result in idealized calibration opportunities occurring somewhat infrequently.

An estimate of an altitude of a mobile device (h_{mobile}) can be computed by the mobile device, a server, or another machine that receives needed information as follows:

$${h}_{mobile} = {h}_{sensor} - \frac{{RT}_{remote}}{gM} ln ( \frac{{P}_{sensor}}{{P}_{mobile}} ) , \qquad ( Equation 1 )$$

where P_{mobile} is the estimate of atmospheric pressure at the location of the mobile device by a barometric pressure sensor of the mobile device, Pₛₑₙₛₒᵣ is an estimate of atmospheric pressure at the location of a reference pressure sensor that is accurate to within a tolerated amount of pressure from true pressure (e.g., less than 5 Pa), Tᵣₑₘₒₜₑ is an estimate of temperature (e.g., in Kelvin) at the location of the reference pressure sensor or a different location of a remote temperature sensor, hₛₑₙₛₒᵣ is an estimated altitude of the reference pressure sensor that is estimated to be within a desired amount of altitude error (e.g., less than 1.0 meters), g corresponds to the acceleration due to gravity, R is a gas constant, and M is the molar mass of air (e.g., dry air or other). The minus sign (−) may be substituted with a plus sign (+) in alternative embodiments of Equation 1, as would be understood by one of ordinary skill in the art. The estimate of pressure at the location of the reference pressure sensor can be converted to an estimated reference-level pressure that corresponds to the reference pressure sensor in that it specifies an estimate of pressure at the latitude and longitude of the reference pressure sensor, but at a reference-level altitude that likely differs from the altitude of the reference pressure sensor. The reference-level pressure can be determined as follows:

$${P}_{ref} = {P}_{sensor} \times exp ( - \frac{gM ( {h}_{ref} - {h}_{sensor} )}{{RT}_{remote}} ) , \qquad ( Equation 2 )$$

where Pₛₑₙₛₒᵣ is the estimate of pressure at the location of the reference pressure sensor, P_{ref} is the reference-level pressure estimate, and href is the reference-level altitude. The altitude of the mobile device h_{mobile} can be computed using Equation 1, where href is substituted for hₛₑₙₛₒᵣ and P_{ref} is substituted for Pₛₑₙₛₒᵣ. The reference-level altitude href may be any altitude and is often set at mean sea-level (MSL). When two or more reference-level pressure estimates are available, the reference-level pressure estimates are combined into a single reference-level pressure estimate value (e.g., using an average, weighted average, or other suitable combination of the reference pressures), and the single reference-level pressure estimate value is used for the reference-level pressure estimate P_{ref}.

The barometric pressure sensor of the mobile device used to determine an altitude estimate as described above is typically inexpensive and susceptible to drift over time. Consequently, the pressure sensor must be frequently calibrated. A typical approach for calibrating a pressure sensor determines a calibration offset value that, when applied to a measurement of pressure by the pressure sensor (P_{mobile}), results in an estimated altitude (h_{mobile}) that is within a tolerated amount of distance from the true altitude. Unfortunately, the barometric pressure sensor of a mobile device cannot be calibrated at every location of the mobile device, especially when the mobile device is not at a known altitude.

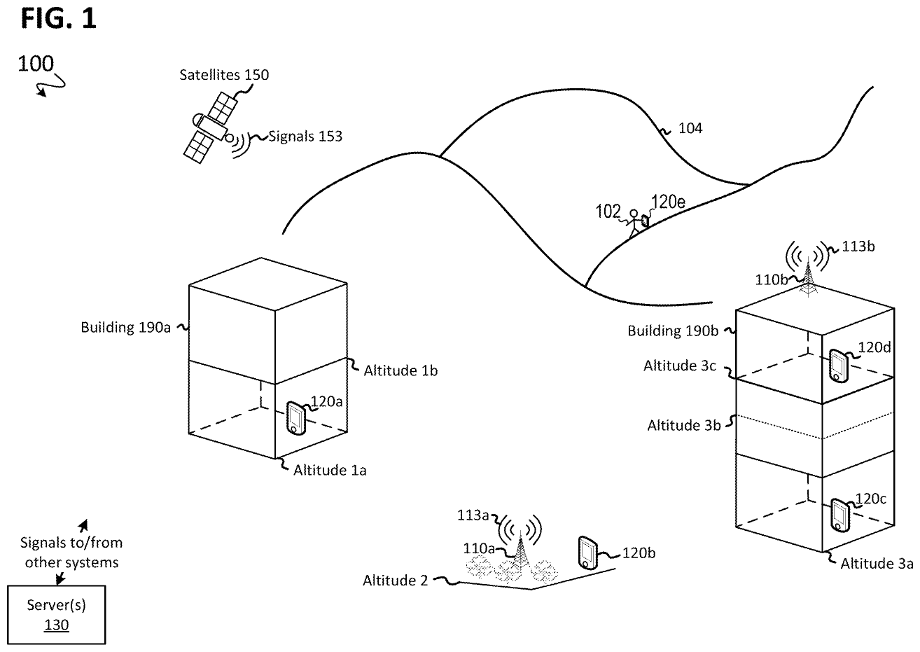

Disclosed herein is a process for calibration of a barometric pressure sensor of a mobile device using less than ideal data, especially data collected indoors or on bumpy terrain, which may be fairly common. Attention is initially drawn to an operational environment 100 illustrated in FIG. 1, in accordance with some embodiments. The operational environment 100 includes a network of terrestrial transmitters 110a-b, buildings 190a-b, and mobile devices 120a-c. Also shown are signals 113a-b, 153, and altitudes designated as Altitudes 1a, 1b, 2, 3a, 3b, and 3c. A user 102 holding a mobile device 120e is shown on bumpy or hilly terrain 104 which varies in altitude. Each of the transmitters 110a-b and the mobile devices 120a-e may be located at different altitudes or depths that are inside or outside of the buildings 190a-b. The term “building” as used herein may refer to any structure having a known or determinable height (e.g., residential buildings, office buildings, monuments, museums, parking garages, shopping centers, venues, construction sites, schools, etc.). The positioning signals 113a-b and 153 are sent to the mobile devices 120a-e from the transmitters 110a-b and the satellites 150, respectively, using known wireless or wired transmission technologies. The transmitters 110a-b may transmit the signals 113a-b using one or more common multiplexing parameters—e.g. time slot, pseudorandom sequence, frequency offset, or other. Any of the mobile devices 120a-e may be implemented as a mobile phone, a tablet, a laptop, a tracking tag, a receiver, or another suitable device that can receive the positioning signals 113a-b and/or 153, and that has a barometric pressure sensor for determining a measurement of atmospheric pressure at a location of the mobile devices 120a-c. The mobile devices 120a-e usually include a respective temperature sensor where a temperature of the barometric pressure sensor or a battery is measured and which can roughly represent an internal temperature of the mobile devices 120a-c. Each of the transmitters 110a-b may also include a barometric pressure sensor and a temperature sensor that respectively measure atmospheric pressure and temperature at the location of the transmitters 110a-b. Measurements of atmospheric pressure and temperature can be used to compute an estimated altitude of the mobile devices 120a-e using Equation 1 as described above.

Conventionally, the pressure sensor of the mobile devices 120a-e cannot be calibrated at every location of the mobile device in the operational environment 100. For example, conventionally only the mobile device 120b, which is outdoors on flat terrain, would be considered to be in an appropriate location due to being at an altitude (Altitude 2) that is close to, or the same as, that of the surrounding terrain. By comparison, the mobile devices 120a, 120c, and 120d are indoors and therefore would not be calibrated using atmospheric pressure data measured by the barometric pressure sensors of those devices. Additionally, the mobile device 120e, which is located on the bumpy or hilly terrain 104, would not conventionally be considered to be in a location suitable for calibration. In some conventional approaches, a barometric pressure sensor of a mobile device that is inside a building is calibrated assuming that the mobile device is at an altitude corresponding to half of the height of that building plus a known altitude of the ground floor or base of the building, because the true altitude of the mobile device within the building is unknown. That is, even though the mobile device 120a is on the ground floor of the building 190a at Altitude 1a, the barometric pressure sensor of the mobile device 120a would be calibrated assuming that the mobile device is at Altitude 1b, which corresponds to half of the building height of the building 190a plus the ground floor altitude. Similarly, the respective barometric pressure sensors of both the mobile devices 120c-d would be calibrated assuming that the mobile devices 120c-d were at Altitude 3b, which corresponds to half of the building height of the building 190b plus the ground floor altitude of the building 190b. In other embodiments, other heights within a building besides the midpoint may be used as an assumed height of the mobile device within the building and, thus, used to determine an assumed altitude of the mobile device. For example, in some embodiments disclosed herein, the highest or lowest height of a building may be used as the assumed height rather than the midpoint. In yet other embodiments, the height corresponding to the middle floor of a building may be used as an assumed height. The selection of which building height to use as an assumed height may be motivated by information such as knowledge that a particular floor, or range of floors, within a building may be inaccessible to a user.

However, as disclosed herein, a known building height plus the ground floor altitude provides contextual information that can be used to convert indoor atmospheric pressure data into valuable opportunities to calibrate the barometric pressure sensor of a mobile device.

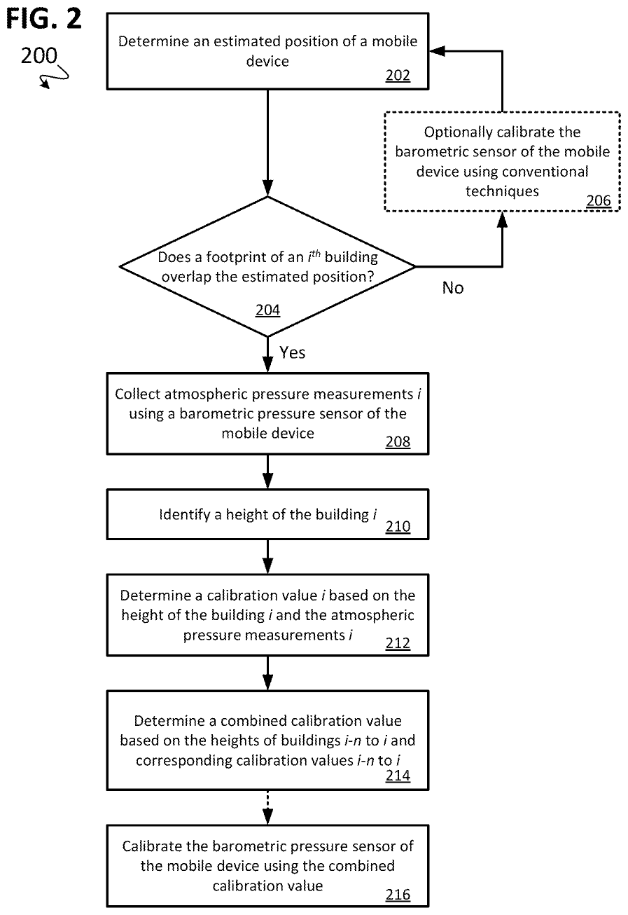

FIG. 2 provides a simplified example of a portion of a process 200 for altitude contextualization for calibrating a barometric pressure sensor of a mobile device, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 202, an estimated position of a mobile device is determined (e.g., using the signals 153 and/or 113a-b shown in FIG. 1). The estimated position may be a 2D or 3D location of the mobile device. At step 204 it is determined if a footprint of an i^{th} building (e.g., an i^{th} building of a set of buildings i-n through i which may be occupied by the mobile device across a range of dates and time) overlaps the estimated position of the mobile device. The set of buildings i-n through i may include instances of unique buildings as well as multiple instances of the same building.

A building footprint is a horizontal two-dimensional boundary that describes the outer perimeter of a building in the context of the surrounding terrain or in raw coordinates. In some embodiments, the estimated position is used to identify terrain data in a terrain database that includes building footprint data. In other embodiments, the estimated position is used to retrieve building footprint data directly from a database or dataset that may or may not contain surrounding terrain data.

In some embodiments, if the estimated position of the mobile device is sufficiently close to a building footprint, such as when a confidence value associated with the estimated position of the mobile device overlaps with the building footprint by a threshold amount, the mobile device is considered to be inside the building. In other embodiments, the mobile device is considered to be inside the building only if the estimated position of the mobile device is entirely within the outer perimeter of a building footprint. If it is determined at step 204 that the mobile device is not inside the i^{th} building, flow of the process 200 continues to optional step 206. At step 206, the barometric pressure sensor of the mobile device is optionally calibrated using conventional techniques (e.g., which may assume that the mobile device is outdoors and is close to the altitude level of the surrounding terrain surface). Flow of the process 200 then returns to step 202. If instead it was determined at step 204 that the footprint of the i^{th} building overlaps the estimated position of the mobile device, flow of the process 200 continues to step 208.

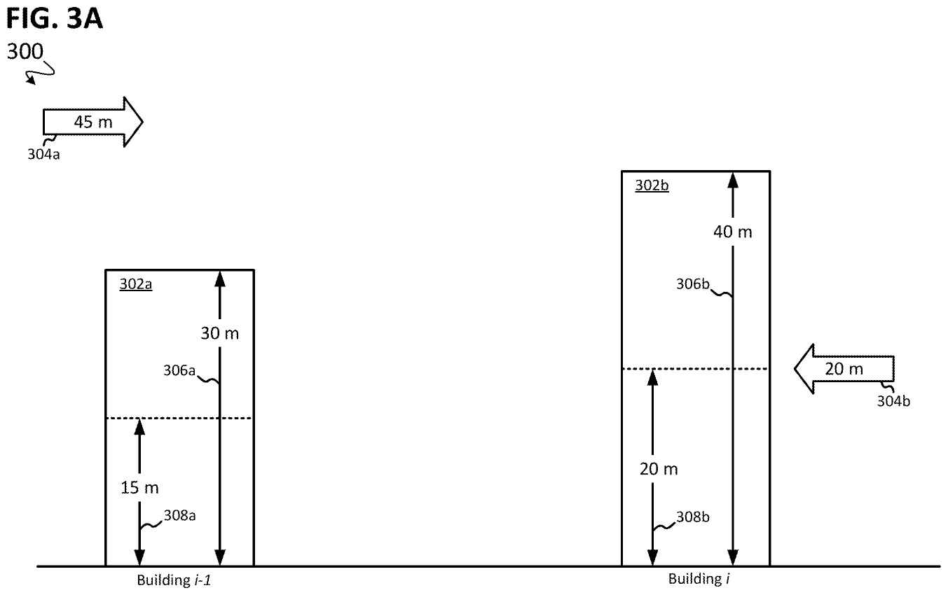

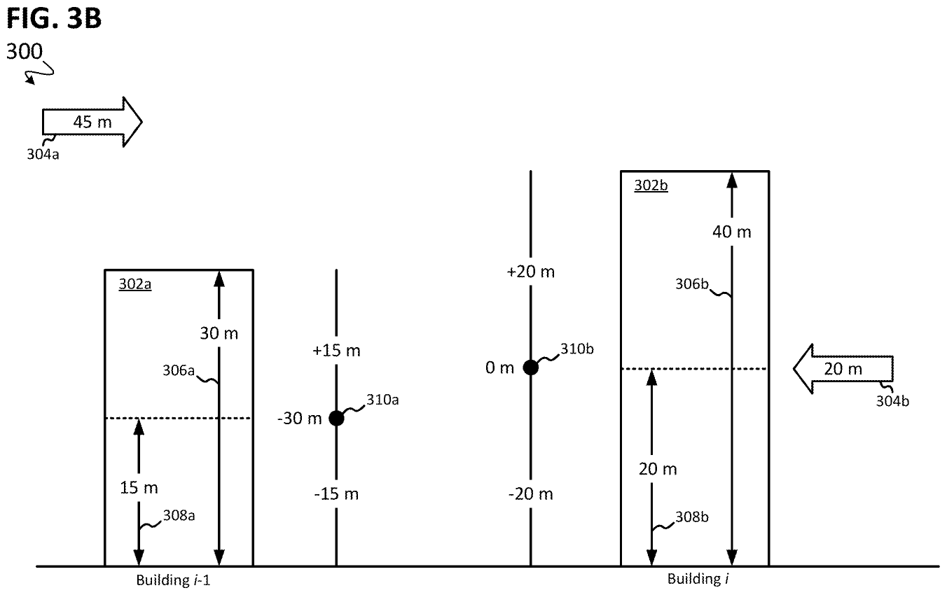

At step 208, an i^{th} set of atmospheric measurements is collected using a barometric pressure sensor of the mobile device inside of the i^{th} building. The i^{th} set of atmospheric measurements is a set of atmospheric measurements explicitly associated with the i^{th} building. At step 210, a height of the i^{th} building is determined (e.g., using data retrieved from the terrain database at step 204). At step 212, an i^{th} calibration value for the barometric sensor of the mobile device is determined based on the height of the i^{th} building, an estimated altitude of the mobile device determined using the i^{th} atmospheric pressure measurements, and an assumed altitude of the mobile device. As described below with reference to FIG. 3A, in some embodiments, the assumed altitude of the mobile device is an altitude that is equal to half of the building's known height above a known altitude of the ground floor of the building. In other embodiments, the assumed altitude of the mobile device is equal to a lowest known altitude (i.e., of the ground floor) or highest known altitude (i.e., of the highest floor) of the building, e.g., when there are multiple altitude values are known for the building but it is not known which is correct or most accurate. In either embodiment, the calibration value is determined using a numerical difference between an uncalibrated estimated altitude determined using the barometric pressure sensor of the mobile device (as described with reference to Equation 1) and the assumed altitude of the mobile device.

A calibration value, as referred to herein, is a set of values that includes a calibration offset value and a calibration confidence value (also referred to as a calibration range). The calibration offset value may represent an offset in atmospheric pressure or altitude that is applied to uncalibrated atmospheric measurements or uncalibrated altitudes, respectively. The calibration offset value may be expressed as a single value or as a polynomial. In other embodiments, the calibration values described herein may include one or more calibration coefficient values (e.g., of a polynomial calibration equation that takes various inputs such as temperature or pressure) and an associated calibration confidence value. The calibration confidence value represents a range of uncertainty of the calibration offset value. In yet other embodiments, calibration values described herein may include both a calibration offset value and one or more calibration coefficient values as well as an associated calibration confidence value. Although calibration offset values are primarily referred to in the examples provided herein, it is understood that any of the calibration offset values could instead be a calibration polynomial depending on design preferences or design requirements of the associated calibration system.

At step 214, as described in detail below, a combined calibration value based on calibration values i-n to i and corresponding building heights i-n to i (and corresponding ground floor altitudes) is determined at the mobile device and/or at a server. In some embodiments, the same process 200 has been performed for some or all of the measurements taken within buildings i-n to i to obtain the calibration values i-n to i. At step 216 the barometric pressure sensor of the mobile device is optionally calibrated, as indicated by the dashed arrow, using the combined calibration value.

Additionally, in some embodiments, the process 200 may be described for multiple estimated positions corresponding to multiple buildings. In this case, the process 200 determines multiple estimated positions of a computing device (e.g., at 204 for each position). Then the process 200 determines, based the estimated positions, each time that the computing device is inside respective buildings (e.g., at 204 when the footprint of any of the buildings overlaps any of the estimated positions). Then the process 200 collects atmospheric pressure measurements each time it is inside any of the respective buildings using a barometric pressure sensor of the computing device (e.g., at 208 for one or more atmospheric pressure measurements in each building). Then the process 200 identifies the respective heights of the buildings (e.g., at 210). Then the process 200 determines multiple calibration values based on the heights of the buildings and the atmospheric pressure measurements (e.g., at 212 for each building and the one or more atmospheric pressure measurements made therein). Then the process 200 determines a combined calibration value using the multiple calibration values and the heights of the buildings, wherein the combined calibration value corresponds to a numerical overlap region of the multiple calibration values (e.g., at 214). Then the process 200 calibrates the barometric sensor using the combined calibration value (e.g., at 216).

Attention is now turned to FIG. 3A, which shows a simplified side-view 300 of example buildings 302a-b (labeled “Building i-1” and “Building i”, respectively). Also shown are uncalibrated mobile device altitude estimates 304a-b above the ground floor altitude (i.e., the height above terrain of the mobile device), building heights 306a-b, and assumed mobile device altitudes 308a-b above the ground floor altitude. In the example shown, the mobile device altitude estimates 304a-b were determined using atmospheric measurements made by an uncalibrated barometric pressure sensor of the mobile device as inputs to a barometric formula such as the one shown in Equation 1. FIG. 3B shows the same simplified side-view 300 and the elements introduced in FIG. 3A, with the addition of a first calibration value 310a determined using an atmospheric pressure measurement made by a barometric pressure sensor of the mobile device while inside the building 302a, and a second calibration value 310b determined using an atmospheric pressure measurement made by the barometric pressure sensor of the mobile device while inside the building 302b. In the example shown, the calibration value 310a for the mobile device within the building 302a was determined using the mobile device altitude estimate 304a, the known maximum building height of 30 m, and an assumed altitude 308a of 15 m (i.e., half of the 30 m building height) to arrive at a calibration offset value of −30 m with a calibration confidence value of +/−15 m. Similarly, the calibration value 310b for the mobile device within the building 302b was determined using the mobile device altitude estimate 304b, the known maximum building height of 40 m, and an assumed altitude 308b of 20 m (i.e., half of the 40 m building height) to arrive at a calibration offset value of 0 m with a calibration confidence of +/−20 m. (Calibration can be in meters as per this example, or it can be in or converted to Pascals in order to calibrate the barometric pressure sensor of the mobile device directly.) In some embodiments, the calibration offset value may be based on a vertical midpoint of floor altitude measurements which are spread across different levels in the building and the confidence may correspond to the range of possible floor altitudes for the building. Additionally, in some embodiments, if the estimated position of the mobile device is not well localized to a single building, then the calibration offset value could be a midpoint of the tallest building within the mobile device's vicinity, or the midpoint of a common building height within the mobile device's vicinity. Examples of such methods are described in U.S. Pat. No. 11,333,567, which issued on May 17, 2022, and is entitled “Constraining Barometric Pressure Sensor Calibration with Sporadic Data Collection”, all of which is incorporated herein in its entirety for all purposes.

In accordance with the calibration process disclosed herein, a calibration value that includes a calibration offset value and an associated calibration confidence value is determined for the mobile device within multiple buildings and/or the same building at multiple times, and then those calibration values are used in conjunction to determine a combined calibration value that is more precise than either of the calibration values individually.

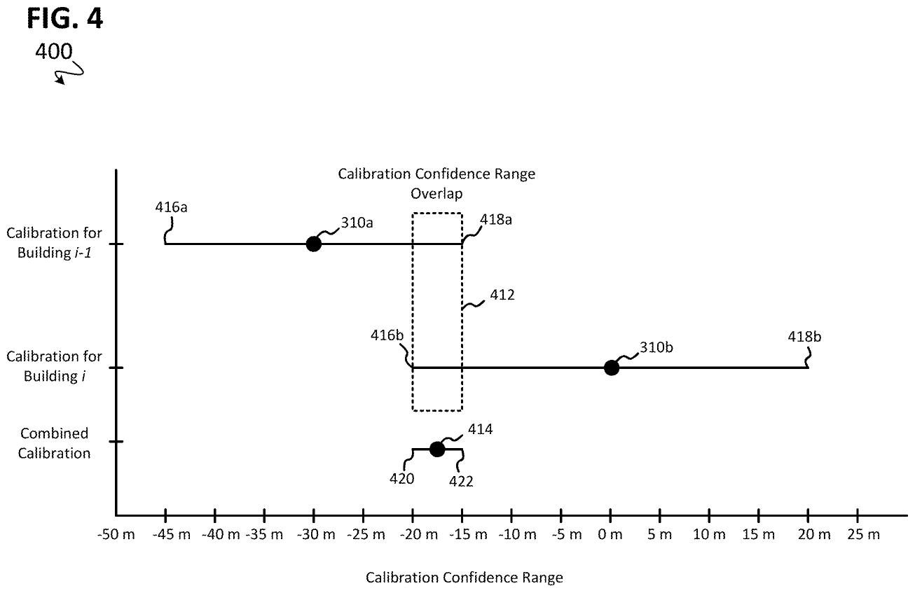

FIG. 4 provides a simplified example graph 400 illustrating how the individual calibration values 310a-b introduced in FIG. 3B are used to generate a combined calibration value, in accordance with some embodiments for when the calibration values 310a and 310b overlap but not completely. As shown, the calibration value 310a has a calibration offset value of −30 m, and an associated calibration confidence value that ranges from −45 m to −15 m (i.e., +/−15 m). By comparison, the calibration value 310b has a calibration offset value of 0 m, and an associated calibration confidence value that ranges from −20 m to 20 m (i.e., +/−20 m). As shown in the graph 400, the calibration values 310a and 310b overlap each other in region 412 by about 5 m. The overlap region 412 is advantageously used to generate a combined calibration value 414 having a calibration offset of −17.5 m (at the center of the overlap region) and an associated calibration confidence value of +/−2.5 m which is significantly more precise than either of the individual calibration values 310a-b and also falls within the calibration uncertainty of the other two calibration values 310a and 310b.

In other words, an example process (with respect to FIG. 4) for determining the combined calibration value (e.g., 414) determines a first calibration offset value (e.g., −30 m) and a first calibration confidence value (e.g., +/−15 m) of the first calibration value (e.g., 310a). The process then determines a first low end (e.g., 416a at −30 m−15 m=−45 m) of the first calibration value (e.g., 310a) equal to the first calibration confidence value (e.g., 15 m) subtracted from the first calibration offset value (e.g., −30 m) and a first high end (e.g., 418a at −30 m+15 m=−15 m) of the first calibration value (e.g., 310a) equal to the first calibration confidence value (e.g., 15 m) added to the first calibration offset value (e.g., −30 m). The process then determines a second calibration offset value (e.g., 0 m) and a second calibration confidence value (e.g., +/−20 m) of the second calibration value (e.g., 310b). The process then determines a second low end (e.g., 416b at 0 m−20 m=−20 m) of the second calibration value (e.g., 310b) equal to the second calibration confidence value (e.g., 20 m) subtracted from the second calibration offset value (e.g., 0 m) and a second high end (e.g., 418b at 0 m+20 m=20 m) of the second calibration value (e.g., 310b) equal to the second calibration confidence value (e.g., 20 m) added to the second calibration offset value (e.g., 0 m). The process then determines a numerical overlap region (or calibration confidence range overlap) as having a low “overlap” end (e.g., 420) equal to the second low end (e.g., 416b at −20 m) and a high “overlap” end (e.g., 422) equal to the first high end (e.g., 418a at −15 m). The numerical overlap region is, thus, based on the higher value of the two low ends 416a-b and the lower value of the two high ends 418a-b. The process then determines the combined calibration value (e.g., 414) as having a combined calibration offset value (−17.5 m) equal to a midpoint between the low overlap end and the high overlap end (i.e., −20 m+(−15 m−(−20 m))/2=−17.5 m) and having a combined calibration confidence value (+/−2.5 m) equal to the low overlap end subtracted from the combined calibration offset value (i.e., −17.5 m−(−20 m)=2.5 m), i.e., half of an extent of the numerical overlap region between the low overlap end and the high overlap end.

In some embodiments, if the calibration values completely overlap with respect to their calibration confidence values, then the resulting combined calibration value is simply the same as whichever of the calibration values has the smallest calibration confidence value.

Due to varying quality of atmospheric pressure measurements made by the mobile device among other factors (such as floor separation assumptions, 2D inaccuracies, building/terrain databases accuracy issues, localized weather effects, etc.), the calibration confidence values may just barely overlap, or may just barely not overlap. In some embodiments, in other words, it may be determined that the calibration confidence values barely overlap, e.g., by less than or equal to a minimum overlap threshold value of about 1 to about 2 m, (i.e., the extent of the numerical overlap region from the low overlap end to the high overlap end is less than or equal to the minimum overlap threshold value). In such a situation, a calibration confidence value calculated by the process described herein might indicate an unreasonably high level of confidence (i.e., too low of an uncertainty, e.g., an uncertainty of 0.1 m when typical expected uncertainties are about 1-1.5 m). To mitigate this situation, in some embodiments, a buffer and/or scaling factor may be applied to the calibration confidence values to facilitate a more reasonable determination of the numerical overlap region. In some embodiments, the buffer and/or scaling factor may be selected based on floor separation values. For example, the buffer and/or scaling factor may be a multiplier that is applied to the calibration confidence values to increase their value to such an extent that the calibration confidence values overlap by at least an acceptable amount, e.g., by greater than or equal to a minimum adjusted overlap threshold value. In other words, the calibration confidence values are increased to generate respective adjusted calibration confidence values (e.g., a first adjusted calibration confidence value of the first calibration value and a second adjusted calibration confidence value of the second calibration value), and an adjusted numerical overlap region is determined therefrom. In some embodiments, the calibration confidence value of only one of the calibration values is adjusted or increased by the buffer and/or scaling factor in order to increase the overlap of the two calibration values. In some embodiments, for example, the buffer and/or scaling factor may be a percentage value by which the calibration confidence values are increased, e.g., about 10% or about 5% to about 20%. The buffer and/or scaling factor should not be too large, because if it requires a relatively large buffer and/or scaling factor to achieve an overlap of the acceptable amount, then it may be likely that one or more of the measurements used to calculate the calibration confidence values and/or the calibration offset values might be erroneous or unreliable. In this case, i.e., when the overlap is too small (or even nonexistent) even after application of the buffer and/or scaling factor, the determination of the combined calibration value should not be performed and the measurements should be discarded. Additionally, the minimum adjusted overlap threshold value (e.g., about 2 to about 5 m) may be selected to ensure that the resulting combined calibration confidence value does not represent too high of a confidence (i.e., too low of an uncertainty), because the buffer and/or scaling factor does not actually represent measured real-world conditions, so the resulting confidence should not be considered to be relatively high. Thus, the minimum adjusted overlap threshold value is a minimum overlap threshold value that has been adjusted to account for a lower confidence due to the application of the buffer and/or scaling factor. Furthermore, in some embodiments, the scaling factor is applied to certain confidence ranges based on certain criteria, e.g., only if the confidence range is within a threshold range (e.g., about 5 m), only if the confidence range is above a threshold limit (e.g., about 50 m), only if the data collected for the calibration was collected outside, only if the data was collected inside, or only if the data was collected inside a building that is larger/smaller than a building size threshold, among other various situations or combinations of situations.

In some scenarios, the building height data used to determine the individual calibration values discussed above may not be accurate and the way in which the building height data is inaccurate may impact the process for calibration value contextualization disclosed above. For example, while it may be accurately determined which building a mobile device is within, the building height data retrieved for that building may be incorrect. Alternatively, the determination of which building the mobile device is within may be inaccurate, and then the building data retrieved is likely to not be accurate given the mobile device's true location. Additionally, in regions where there is little altitude diversity, meaning the user does not change floors in the same or different buildings within an acceptable time frame of interest, the overlap region may not shrink or converge to an acceptable range (e.g. ideally within 5 m or 50 Pa). That is, if the measurements within a building at different floors were made months apart, measurements of the barometric sensor of the mobile device may have drifted, and thus such measurements are less useful than measurements made within a narrow time frame (e.g., minutes, hours, or days).

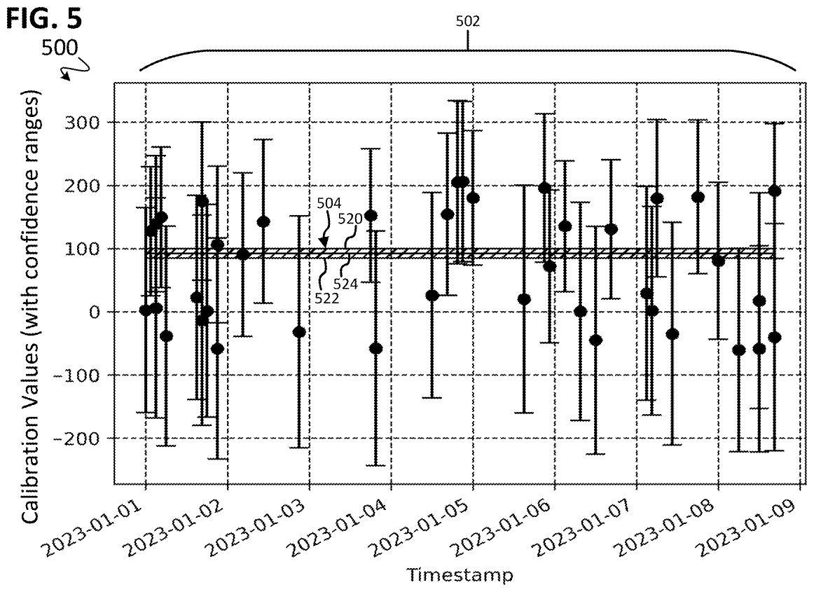

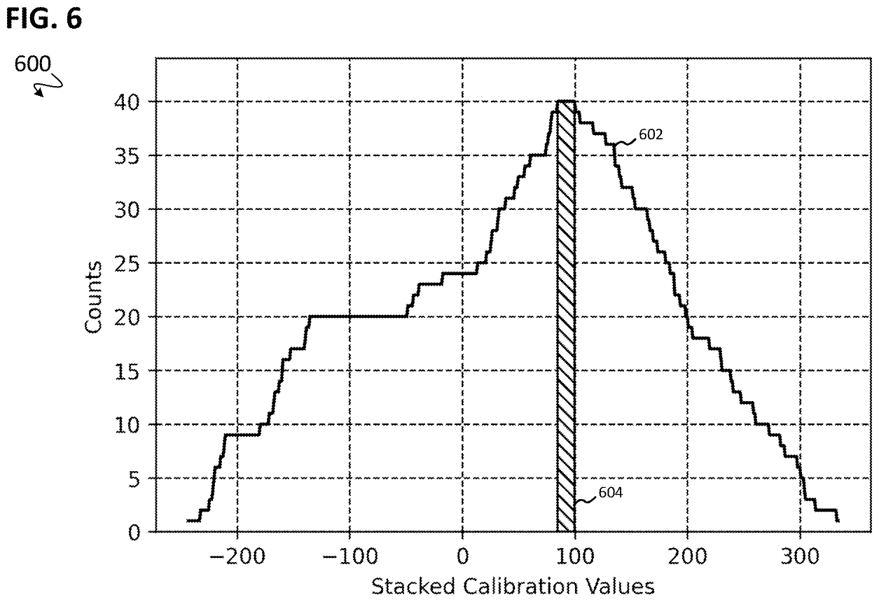

FIG. 5 provides an example graph 500 of a distribution of calibration offsets and calibration confidence ranges 502, in units of meters or Pascals, determined using a barometric pressure sensor of a mobile device over time in a variety of locations (i.e., within buildings and outdoors) within a region, in accordance with some embodiments. Also shown is a numerical overlap region or range 504 that contains or represents the greatest overlap of the calibration values (i.e., a highest frequency of numerical overlap within the complete set of calibration values) based on their calibration confidence values or ranges 502. The greatest overlap may be used in this example, because it is possible that a situation might occur in which some of the calibration values have an overlap with only some, but not all, of the other calibration values, but it may still be possible to select a numerical overlap region that is overlapped by the largest number of the calibration values. The calibration confidence values were then used as input data to the process 200 shown in FIG. 2. FIG. 6 provides a graph 600 of example results 602 for determining an overlap of the calibration confidence values 502 shown in FIG. 5, in accordance with some embodiments. In the example shown in FIG. 6, the calibration values 502 of FIG. 5 were “stacked” to form a histogram 602 having a peak value where the greatest amount of overlap occurred. A numerical range 604 indicates a known correct calibration range for the barometric sensor. As shown in FIG. 6, the correct calibration region 604 occurs at the peak value of the histogram 602. In some embodiments, a resultant combined calibration offset value corresponds to the peak value of the histogram 602 (or a center of the peak value) and the combined calibration confidence value may be derived using a spread of the peak of the histogram 602 (e.g., half of the spread), or a deviation from a central tendency thereof. In other embodiments, the combined calibration confidence value may occur within a threshold value of the peak value (e.g., within a spread of 30 Pa, or +/−15 Pa) and may not necessarily perfectly align with the peak calibration value.

Another example process for determining the combined calibration value determines calibration offset values and calibration confidence values or ranges of multiple calibration values (e.g., 502). The process then determines respective low ends and respective high ends of the multiple calibration values based on the calibration offset values and the calibration confidence values of the plurality of calibration values (e.g., similar to that described for the previous example process with respect to FIG. 4). The process then determines a numerical overlap region or range (e.g., 504) as having a low overlap end (e.g., 520) based on the highest low end of all of the calibration values and a high overlap end (e.g., 522) based on the lowest high end of all of the calibration values. For example, the low overlap end (e.g., 520) may be equal to the highest low end of all of the calibration values and the high overlap end (e.g., 522) may be equal to the lowest high end of all of the calibration values. Alternatively, the low overlap end and/or the high overlap end may be based on a percentile, e.g., the low overlap end may be set by a low end percentage value (e.g., at about 5%) from the highest low end of the calibration values, and the high overlap end may be set by a low end percentage value (e.g., at about 5%) from the lowest high end of the calibration values for a percentile range of 5-95% between the highest low end and the lowest high end. The process then determines the combined calibration value, for example, the combined calibration value may be selected as having a combined calibration offset value (e.g., 524) equal to a midpoint between the low overlap end (e.g., 520) and the high overlap end (e.g., 522) and having a combined calibration confidence value equal to the low overlap end (e.g., 520) subtracted from the combined calibration offset value (e.g., 524). Alternatively, the combined calibration offset value may be selected based on a percentile of the distribution of the multiple calibration values or minimum or maximum of the multiple calibration values. In some embodiments, this selection can be determined based on physical constraints such as aligning the combined calibration value to a floor level (plus an appropriate offset), among other considerations.

In some embodiments, the process 200 for altitude contextualization for calibrating a barometric pressure sensor, as disclosed above, may also be applied to data collected outdoors (i.e., not within a building or other structure) to advantageously calibrate mobile devices that are outdoors at an ambiguous altitude due to hilly/sloped (“bumpy”) terrain. So-called bumpy terrain that is traversable by people typically varies in elevation by no more than a few meters to 10 meters (i.e., corresponding to the quality of a typical mobile device 2D or horizontal position estimate). By comparison, most buildings have floor separations on the order of 3-4 meters per floor, which means that for a tall building with a large number of floors, the altitude distribution could be very large. Thus, floor separations in buildings typically cause a wider distribution of possible altitudes than bumpy terrain alone.

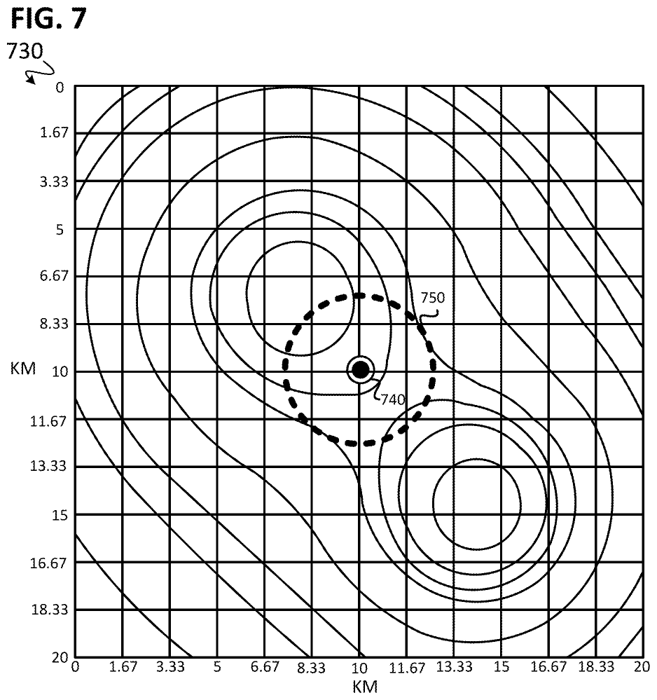

With reference to the bumpy or hilly terrain 104 shown in FIG. 1, when a mobile device is located at such terrain, an altitude estimate thereof may have some ambiguity due to a large terrain distribution within a 2D or horizontal uncertainty region of the mobile device's estimated position. For example, FIG. 7 provides a simplified topographic map 730 of the hilly terrain 104 shown in FIG. 1, in accordance with some embodiments. A 2D position estimate 740 of the mobile device 120e has an associated 2D uncertainty region 750 which encompasses several changes in terrain elevation. Conventionally, mobile devices within such uneven terrain conditions are not at an ideal location for calibration. For example, U.S. Pat. No. 11,555,699, issued Jan. 17, 2023, and entitled “Systems and Methods for Determining When An Estimated Altitude of a Mobile Device Can Be Used For Calibration or Location Determination” provides a description for determining a flatness metric of an area and generating terrain distributions to determine if a location is well suited for calibrating the barometric sensor of a mobile device.

Similar to the altitude contextualization process 200 described above for indoor locations, calibration offset and confidence values may be generated by the mobile device 120e using a midpoint altitude of a terrain distribution of the region surrounding the mobile device 120e as the assumed altitude, as well as the vertical spread of the terrain distribution. Thus, the calibration offset value for each estimated 2D position is the midpoint altitude of the terrain distribution plus an optional offset above this altitude (e.g., 1 m) within the horizontal uncertainty region for that estimated 2D position. Additionally, the calibration confidence value for each estimated 2D position is the vertical spread of the terrain distribution within the horizontal uncertainty region for that estimated 2D position. For example, the midpoint could be the median of the distribution, and the spread could be the deviation from a central tendency. As the mobile device 120e travels through the region, additional calibration values may be generated using additional terrain distributions within the region. A set of calibration values i-n through i, corresponding to different or nearby terrain distributions i-n through i, may then be used by the mobile device and/or a server to determine a numerical overlap region of the associated confidence values to generate a combined calibration value similar to as described above.

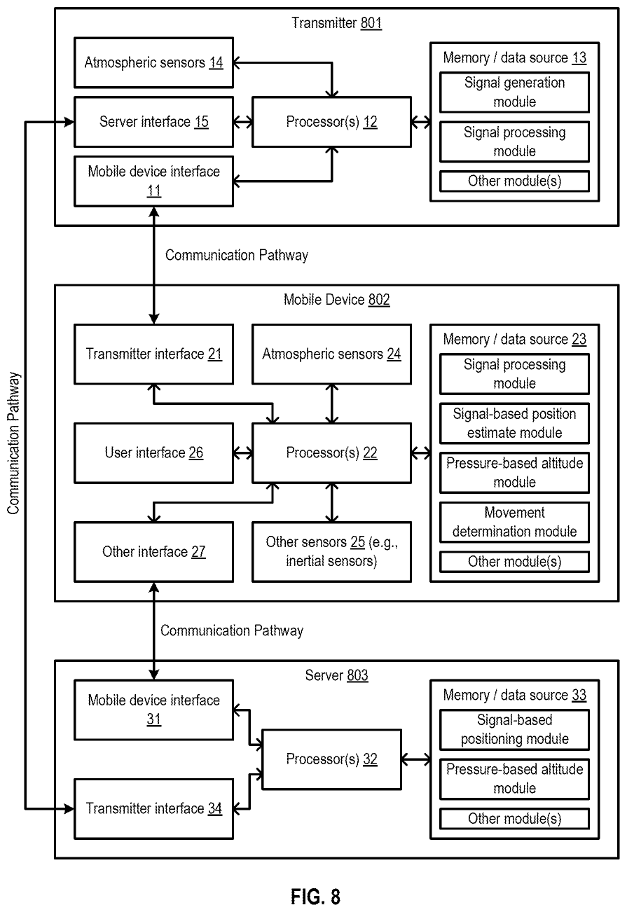

FIG. 8 illustrates components of an example transmitter 801 (e.g., one of the transmitters 110a-b), an example mobile device 802 (e.g., one of the mobile devices 120a-c), and an example server 803 (e.g., any one of the servers 130) of the operational environment 100 shown in FIG. 1, in accordance with some embodiments. Examples of communication pathways are shown by arrows between components. The components shown in FIG. 8 are operable to perform all or a portion of the process 200.

By way of example in FIG. 8, each of the transmitters 801 may include: a mobile device interface 11 for exchanging information with a mobile device (e.g., antenna(s) and RF front-end components known in the art or otherwise disclosed herein); one or more processor(s) 12; memory/data source 13 for providing storage and retrieval of information and/or program instructions; atmospheric sensor(s) 14 for measuring environmental conditions (e.g., pressure, temperature, humidity, other) at or near the transmitter; a server interface 15 for exchanging information with a server (e.g., an antenna, a network interface, or other); and any other components known to one of ordinary skill in the art. The memory/data source 13 may include a memory storing software modules with executable instructions, and the processor(s) 12 may perform different actions by executing the instructions from the modules, including (i) performance of a part or all of the methods as described herein or otherwise understood by one of skill in the art as being performable at the transmitter; (ii) generation of positioning signals for transmission using a selected time, frequency, code, and/or phase; (iii) processing of signals received from the mobile device or another source; or (iv) other processing as required by operations described in this disclosure. Signals generated and transmitted by a transmitter may carry different information that, once determined by a mobile device or a server, may identify the following: the transmitter; the transmitter's position; environmental conditions at or near the transmitter; and/or other information known in the art. The atmospheric sensor(s) 14 may be integral with the transmitter, or separate from the transmitter and either co-located with the transmitter or located in the vicinity of the transmitter (e.g., within a threshold amount of distance).

By way of example in FIG. 8, the mobile device 802 may include: a transmitter interface 21 for exchanging information with a transmitter (e.g., an antenna and RF front-end components known in the art or otherwise disclosed herein); one or more processor(s) 22; memory/data source 23 for providing storage and retrieval of information and/or program instructions; atmospheric sensor(s) 24 (such as barometers and temperature sensors) for measuring environmental conditions (e.g., pressure, temperature, other) at the mobile device; other sensor(s) 25 for measuring other conditions (e.g., inertial sensors for measuring movement and orientation); a user interface 26 (e.g., display, keyboard, microphone, speaker, other) for permitting a user to provide inputs and receive outputs; another interface 27 for exchanging information with the server or other devices external to the mobile device (e.g., an antenna, a network interface, or other); and any other components known to one of ordinary skill in the art. A GNSS interface and processing unit (not shown) are contemplated, which may be integrated with other components (e.g., the interface 21 and the processors 22) or a standalone antenna, RF front end, and processors dedicated to receiving and processing GNSS signaling. The memory/data source 23 may include a memory (e.g., a data storage module) storing software modules with executable instructions, and the processor(s) 22 may perform different actions by executing the instructions from the modules, including (i) performance of a part or all of the methods as described herein or otherwise understood by one of ordinary skill in the art as being performable at the mobile device; (ii) estimation of an altitude of the mobile device based on measurements of pressure from the mobile device and transmitter(s), temperature measurement(s) from the transmitter(s) or another source, and any other information needed for the computation); (iii) processing of received signals to determine position information (e.g., times of arrival or travel time of the signals, pseudoranges between the mobile device and transmitters, transmitter atmospheric conditions, transmitter and/or locations or other transmitter information); (iv) use of position information to compute an estimated position of the mobile device; (v) determination of movement based on measurements from inertial sensors of the mobile device; (vi) GNSS signal processing; or (vii) other processing as required by operations described in this disclosure.

By way of example in FIG. 8, the server 803 may include: a mobile device interface 31 for exchanging information with a mobile device (e.g., an antenna, a network interface, or other); one or more processor(s) 32; memory/data source 33 for providing storage and retrieval of information and/or program instructions; a transmitter interface 34 for exchanging information with a transmitter (e.g., an antenna, a network interface, or other); and any other components known to one of ordinary skill in the art. The memory/data source 33 may include a memory storing software modules with executable instructions, and the processor(s) 32 may perform different actions by executing instructions from the modules, including (i) performance of a part or all of the methods as described herein or otherwise understood by one of ordinary skill in the art as being performable at the server; (ii) estimation of an altitude of the mobile device; (iii) computation of an estimated position of the mobile device; or (iv) other processing as required by operations described in this disclosure. Steps performed by servers as described herein may also be performed on other machines that are remote from a mobile device, including computers of enterprises or any other suitable machine.

Certain aspects disclosed herein relate to estimating the positions of mobile devices—e.g., where the position is represented in terms of latitude, longitude, and/or altitude coordinates; x, y, and/or z coordinates; angular coordinates; or other representations. Various techniques to estimate the position of a mobile device can be used, including trilateration, which is the process of using geometry to estimate the position of a mobile device using distances traveled by different “positioning” (or “ranging”) signals that are received by the mobile device from different beacons (e.g., terrestrial transmitters and/or satellites). If position information like the transmission time and reception time of a positioning signal from a beacon is known, then the difference between those times multiplied by the speed of light would provide an estimate of the distance traveled by that positioning signal from that beacon to the mobile device. Different estimated distances corresponding to different positioning signals from different beacons can be used along with position information like the locations of those beacons to estimate the position of the mobile device. Positioning systems and methods that estimate a position of a mobile device (in terms of latitude, longitude, and/or altitude) based on positioning signals from beacons (e.g., transmitters, and/or satellites) and/or atmospheric measurements are described in co-assigned U.S. Pat. No. 8,130,141, issued Mar. 6, 2012, and U.S. Pat. No. 9,057,606, issued Jun. 16, 2015, incorporated by reference herein in its entirety for all purposes. It is noted that the term “positioning system” may refer to satellite systems (e.g., Global Navigation Satellite Systems (GNSS) like GPS, GLONASS, Galileo, and Compass/Beidou), terrestrial transmitter systems, and hybrid satellite/terrestrial systems.

Reference has been made in detail to embodiments of the disclosed invention, one or more examples of which have been illustrated in the accompanying figures. Each example has been provided by way of an explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
determining a first estimated position of a computing device;
determining, based on the first estimated position, that the computing device is inside a first building;
collecting first atmospheric pressure measurements inside the first building using a barometric pressure sensor of the computing device;
identifying a height of the first building;
determining a first calibration value based on the height of the first building and the first atmospheric pressure measurements;
determining a combined calibration value based on the first calibration value and a second calibration value that was determined for the first building or a second building, the combined calibration value corresponding to a numerical overlap region of the first calibration value and the second calibration value; and
calibrating the barometric pressure sensor using the combined calibration value.

2. The method of claim 1, wherein determining the combined calibration value further comprises:
determining a first low end and a first high end of the first calibration value;
determining a second low end and a second high end of the second calibration value;
determining the numerical overlap region as having a low overlap end equal to the higher value of the first low end and the second low end and a high overlap end equal to the lower value of the first high end and the second high end; and
determining the combined calibration value as having a combined calibration offset value equal to a midpoint of the numerical overlap region and having a combined calibration confidence value equal to half of an extent of the numerical overlap region.

3. The method of claim 1, wherein determining the combined calibration value further comprises:
determining a first calibration offset value and a first calibration confidence value of the first calibration value;
determining a first low end of the first calibration value equal to the first calibration confidence value subtracted from the first calibration offset value and a first high end of the first calibration value equal to the first calibration confidence value added to the first calibration offset value;
determining a second calibration offset value and a second calibration confidence value of the second calibration value;
determining a second low end of the second calibration value equal to the second calibration confidence value subtracted from the second calibration offset value and a second high end of the second calibration value equal to the second calibration confidence value added to the second calibration offset value;
determining the numerical overlap region as having a low overlap end equal to the second low end and a high overlap end equal to the first high end; and
determining the combined calibration value as having a combined calibration offset value equal to a midpoint between the low overlap end and the high overlap end and having a combined calibration confidence value equal to the low overlap end subtracted from the combined calibration offset value.

4. The method of claim 1, wherein determining the combined calibration value further comprises:
determining that the numerical overlap region is less than or equal to a minimum overlap threshold value;
increasing a first calibration confidence value of the first calibration value and a second calibration confidence value of the second calibration value by a scaling factor to generate a first adjusted calibration confidence value of the first calibration value and a second adjusted calibration confidence value of the second calibration value;
determining an adjusted numerical overlap region based on the first adjusted calibration confidence value and the second adjusted calibration confidence value; and
determining the combined calibration value based on the adjusted numerical overlap region.

5. The method of claim 1, wherein determining the combined calibration value further comprises:
determining that the first calibration value and the second calibration value completely overlap; and
determining that the combined calibration value is whichever of the first calibration value and the second calibration value has a smaller calibration confidence value.

6. The method of claim 1, wherein determining the combined calibration value further comprises:
determining a first calibration confidence value of the first calibration value;
determining a second calibration confidence value of the second calibration value;
determining that the first calibration value and the second calibration value completely overlap with respect to the first calibration confidence value and the second calibration confidence value;
determining that the second calibration confidence value is smaller than the first calibration confidence value; and
determining that the combined calibration value is second calibration value.

7. The method of claim 1, further comprising:
determining a second estimated position of the computing device;
determining, based on the second estimated position, that the computing device is inside the second building;
collecting second atmospheric pressure measurements inside the second building using the barometric pressure sensor of the computing device;
identifying a height of the second building; and
determining the second calibration value based on the height of the second building and the second atmospheric pressure measurements.

8. A method comprising:
determining a plurality of estimated positions of a computing device;
determining, based the plurality of estimated positions, each time that the computing device is inside respective buildings of a plurality of buildings;
collecting a plurality of atmospheric pressure measurements when inside the respective buildings of the plurality of buildings using a barometric pressure sensor of the computing device;
identifying a respective plurality of heights of the plurality of buildings;
determining a plurality of calibration values based on the heights of the buildings and the atmospheric pressure measurements;
determining a combined calibration value based on the plurality of calibration values, the combined calibration value corresponding to a numerical overlap region of the plurality of calibration values; and
calibrating the barometric pressure sensor using the combined calibration value.

9. The method of claim 8, wherein:
the numerical overlap region is based on a highest low end of the calibration values and a lowest high end of the calibration values.

10. The method of claim 8, wherein:
the numerical overlap region represents a greatest overlap of the calibration values.

11. The method of claim 8, wherein determining the combined calibration value further comprises:
determining calibration offset values and calibration confidence values of the plurality of calibration values;
determining respective low ends of the calibration values and respective high ends of the plurality of calibration values based on the calibration offset values and the calibration confidence values of the plurality of calibration values;
determining the numerical overlap region having a low overlap end based on the low ends of the calibration values and a high overlap end based on the high ends of the calibration values; and
determining the combined calibration value as having a combined calibration offset value equal to a midpoint between the low overlap end and the high overlap end and having a combined calibration confidence value equal to the low overlap end subtracted from the combined calibration offset value.

12. The method of claim 11, wherein:
the low overlap end is based on a highest low end of the low ends of the calibration values; and
the high overlap end is based on a lowest high end of the high ends of the calibration values.

13. The method of claim 12, wherein:
the low overlap end is equal to the highest low end of the low ends of the calibration values; and
the high overlap end is equal to the lowest high end of the high ends of the calibration values.

14. The method of claim 12, wherein:
the low overlap end is set by a low end percentage value from the highest low end of the low ends of the calibration values; and
the high overlap end is set by a high end percentage value from the lowest high end of the high ends of the calibration values.

15. A method comprising:
determining a plurality of estimated positions of a computing device;
collecting a plurality of atmospheric pressure measurements at the plurality of estimated positions using a barometric pressure sensor of the computing device;
determining a plurality of horizontal uncertainty regions corresponding to the plurality of estimated positions;
determining a plurality of terrain distributions corresponding to the plurality of horizontal uncertainty regions;
determining a plurality of calibration values based on the plurality of terrain distributions and the atmospheric pressure measurements;
determining a combined calibration value based on the plurality of calibration values, the combined calibration value corresponding to a numerical overlap region of the plurality of calibration values; and
calibrating the barometric pressure sensor using the combined calibration value.

16. The method of claim 15, wherein:
the numerical overlap region is based on a highest low end of the calibration values and a lowest high end of the calibration values.

17. The method of claim 15, wherein:
the numerical overlap region represents a greatest overlap of the calibration values.

18. The method of claim 15, wherein determining the combined calibration value further comprises:
determining calibration offset values and calibration confidence values of the plurality of calibration values;
determining respective low ends of the calibration values and respective high ends of the plurality of calibration values based on the calibration offset values and the calibration confidence values of the plurality of calibration values;
determining the numerical overlap region having a low overlap end based on the low ends of the calibration values and a high overlap end based on the high ends of the calibration values; and
determining the combined calibration value as having a combined calibration offset value equal to a midpoint between the low overlap end and the high overlap end and having a combined calibration confidence value equal to the low overlap end subtracted from the combined calibration offset value.

19. The method of claim 18, wherein:
the low overlap end is based on a highest low end of the low ends of the calibration values; and
the high overlap end is based on a lowest high end of the high ends of the calibration values.
